(19) United States
(12) Patent Application Publication
(10) Pub. No.: US 2012/0024081 A1
(43) Pub. Date: Feb. 2, 2012

(54) TRAILER HITCH MONITORING APPARATUS AND METHOD

(76) Inventor: Douglas Baker, Ypsilanti, MI (US)

(21) Appl. No.: 13/194,425

(22) Filed: Jul. 29, 2011

Related U.S. Application Data
(60) Provisional application No. 61/368,739, filed on Jul. 29, 2010.

(51) Int. Cl. G01L 1/22; B60D 1/06

(52) U.S. Cl. 73/862.338; 280/511

(57) ABSTRACT

A trailer hitch assembly is provided for monitoring trailer hitch loads comprising a hitch support and a hitch coupled to the hitch support including a hitch base having a hitch base radius, a hitch ball disposed on and above the hitch base, and a lug extending downwardly from the hitch base. An instrument spacer is disposed between the hitch base and the hitch support defining a cylindrical bore receiving the lug. The cylindrical bore extends along a central bore axis and has a bore radius that is less than the hitch base radius. At least one strain gauge is disposed on the instrument spacer at a radial distance from the central bore axis that is less than or equal to the hitch base radius and greater than or equal to the bore radius.

### CROSS REFERENCE TO RELATED APPLICATION

This application claims the benefit of application Ser. No. 61/368,739 filed Jul. 29, 2010.

### BACKGROUND OF THE INVENTION

1. Field of the Invention

An assembly for monitoring the trailer hitch loads of a tow vehicle is provided in addition to a trailer hitch monitoring apparatus and a method for monitoring a trailer hitch assembly.

2. Description of the Prior Art

Various assemblies for monitoring trailer hitch loads are well known in the art. An example of such assemblies are disclosed in U.S. Pat. No. 6,053,521 to Schertler and U.S. Pat. No. 6,253,626 to Shoberg et al.

Schertler discloses an assembly for monitoring the trailer hitch loads of a tow vehicle including a hitch support for attachment with the tow vehicle. Schertler also discloses a hitch including a hitch base having a hitch base radius. The hitch also includes a hitch ball disposed on and above the hitch base and a lug. The lug has a cylindrical shape and extends downwardly from the hitch base. The lug has threads and a lug radius that is less than the hitch base radius. A nut having threads is disclosed for threadedly engaging the lug of the hitch to couple the hitch and the hitch support.

Shoberg et al. discloses an instrument spacer disposed between the hitch base and the hitch support. The instrument spacer includes a top surface abutting the hitch base and a bottom surface abutting the hitch support. The instrument spacer defines a bore. At least one strain gauge is disposed on the instrument spacer generating a resistance change for measuring forces applied to the instrument spacer. A data acquisition system electrically connected to the at least one strain gauge is provided. The data acquisition system includes a Wheatstone bridge circuit measuring the resistance change of the at least one strain gauge and generating a force measurement.

Wireless transmitters, receivers, and simple user information displays are also well known in the art. This includes a transmitter electrically connected to the Wheatstone bridge circuit for wirelessly transmitting the force measurement, a receiver base including a receiver receiving the force measurement from the transmitter, and a user information display electrically connected to the receiver and graphically presenting the force measurement.

In view of the prior art referenced herein, various methods for monitoring a trailer hitch assembly are also known in the art. The known methods include monitoring a trailer hitch assembly including a hitch support and a hitch. The hitch includes a hitch base having a hitch base radius. The hitch also includes a lug extending from the hitch base. The assembly also includes an instrument spacer disposed between the hitch base and the hitch support. The instrument spacer defines a cylindrical bore. The assembly further includes at least one strain gauge disposed on the instrument spacer generating a resistance change and a user information display. The known methods include the steps of measuring the resistance change of the at least one strain gauge using a Wheatstone bridge circuit, calculating a resultant force value in response to measuring the resistance change of the least one strain gauge, and displaying at least one of the resultant force value on the user information display.

### SUMMARY OF THE INVENTION

The subject invention provides for the assembly for monitoring the trailer hitch loads of a tow vehicle described above further comprising at least one strain gauge disposed on the instrument spacer at a radial distance from the central bore axis being less than or equal to the hitch base radius and greater than or equal to the bore radius.

The subject invention also provides a method for monitoring a trailer hitch assembly described above further comprising the steps of positioning the at least one strain gauge on the instrument spacer at a radial distance from the central bore axis being less than or equal to the hitch base radius and greater than or equal to the bore radius and calculating a torque value in response to measuring the resistance change of the least one strain gauge.

### ADVANTAGES OF THE INVENTION

The subject invention provides several advantages. Unlike prior art designs the subject invention allows for detection of proper torque applied to the hitch and nut during hitch ball installation. This is useful because proper installation of the hitch ball is critical for safe towing. The inadequate application of torque to the nut during installation may enable the nut to work loose during towing causing catastrophic failure of the trailer hitch. The arrangement of the strain gauges pursuant to the subject invention allows for detection of correct installation torque on the hitch and the nut and can provide a warning when the hitch has not been installed properly. The subject invention further provides a warning when the nut has worked itself loose or when the trailer hitch assembly has been tampered with.

The subject invention also provides for the detection of tongue weight, towing load capacity, and secure hitch ball to trailer coupling. Accordingly, the subject invention detects unsafe towing conditions and may warn the user before a catastrophic event occurs. The towing load on a vehicle is a function of many factors including but not limited to vehicle speed, road grade, road conditions, wind direction, wind magnitude, tire inflation pressure, and drag forces. When the towing load becomes too great, damage to the tow vehicle can occur. Additionally, overloading a trailer can cause unsafe towing conditions and may lead to failure of the trailer hitch assembly. The subject invention continuously monitors the trailer hitch assembly and initiates a warning where unsafe conditions have been reached. The subject invention can also be used as a theft detection system by detecting slight changes in trailer load and activating a security alarm to ward off potential tampering and theft.

Unlike prior art designs, the subject invention can also be easily installed on existing trailer hitch hardware. Where prior art designs require purchase of new trailer hitch receivers, hitch balls, and hitch supports, the instrument spacer of the subject invention simply mounts to the existing hitch support using the existing hitch ball, lug, and nut for attachment. Thus, the subject invention may be easily retro-fit to existing trailer hitch hardware at minimal cost.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is an elevation view of the hitch of the subject invention illustrating the forces applied to the hitch during acceleration and deceleration,

FIG. 2 is a perspective view of hitch of the subject invention illustrating the area of force transference between the hitch base and the instrument spacer,

FIG. 3 is a side elevation view of the hitch of the subject invention illustrating the forces acting on the hitch,

FIG. 4 is a side elevation view of the hitch of the subject invention illustrating the forces acting on the hitch during acceleration,

FIG. 5 is a side elevation view of the hitch of the subject invention illustrating the forces acting on the hitch during deceleration,

FIG. 6 is a top view of the instrument spacer of the subject invention illustrating the area of force application on the instrument spacer,

FIG. 7 is a schematic of the data acquisition system of the subject invention,

FIG. 8 is a top view of the instrument spacer of the subject invention illustrating arrangements of the at least one strain gauge on the instrument spacer,

FIG. 9 is a perspective view of the instrument spacer of the subject invention illustrating arrangements of the at least one strain gauge on the instrument spacer,

FIG. 10 is an elevation view of the hitch assembly of the subject invention illustrating the x-axis and the y-axis and the z-axis,

FIG. 11 is an exploded view of trailer hitch assembly of the subject invention,

FIG. 12 is a front elevation view of the receiver base and the user information display of the subject invention, and

FIG. 13 is a perspective view of trailer hitch assembly of the subject invention.

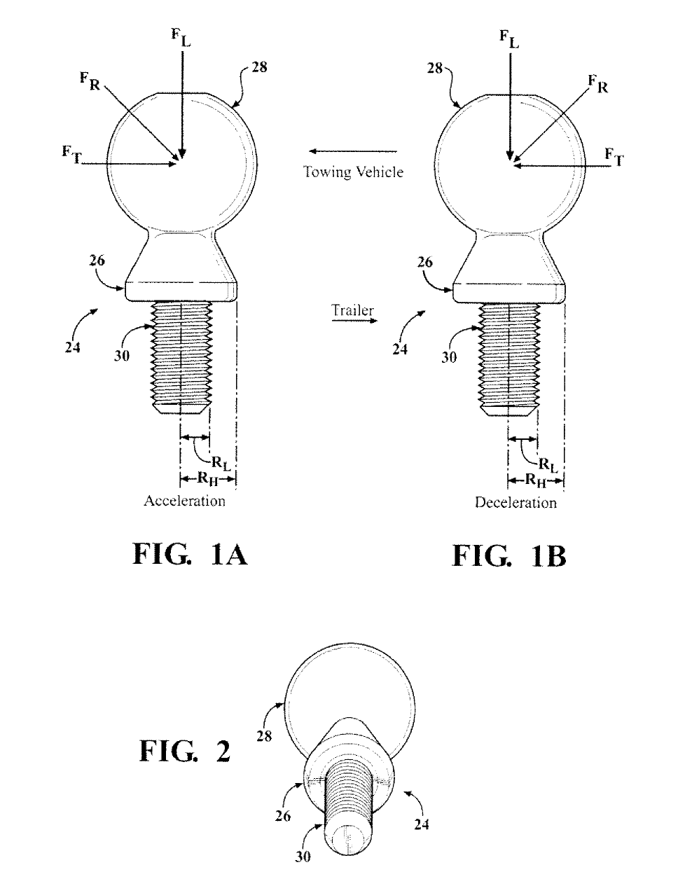

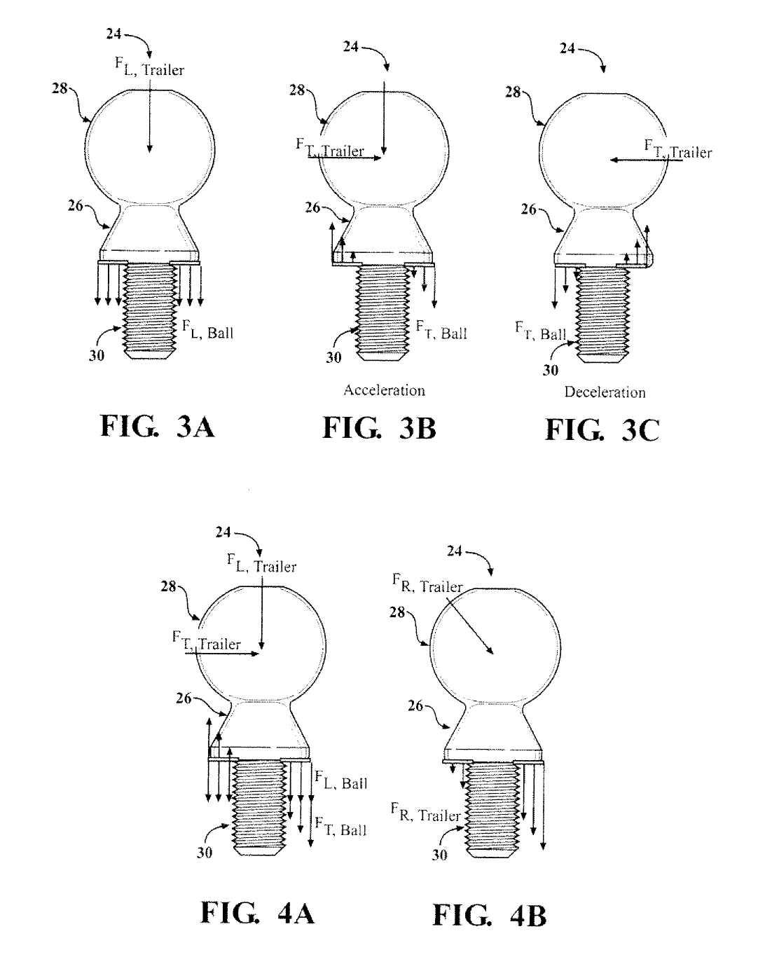

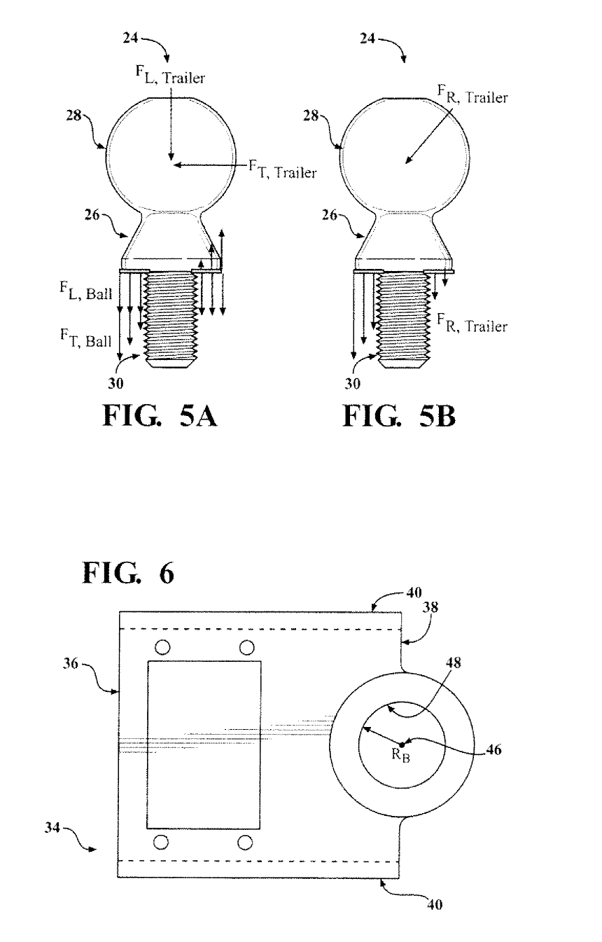

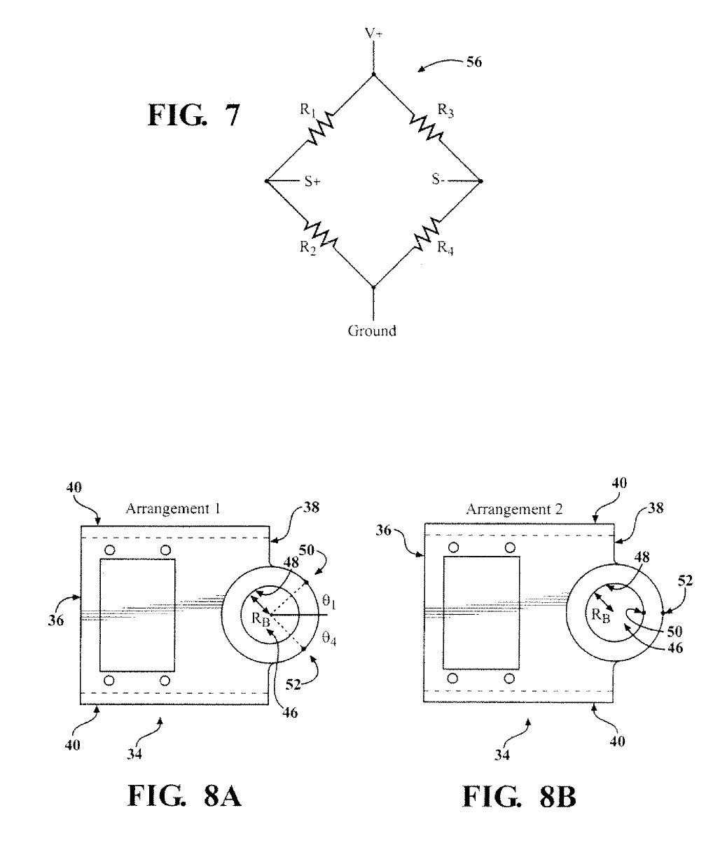

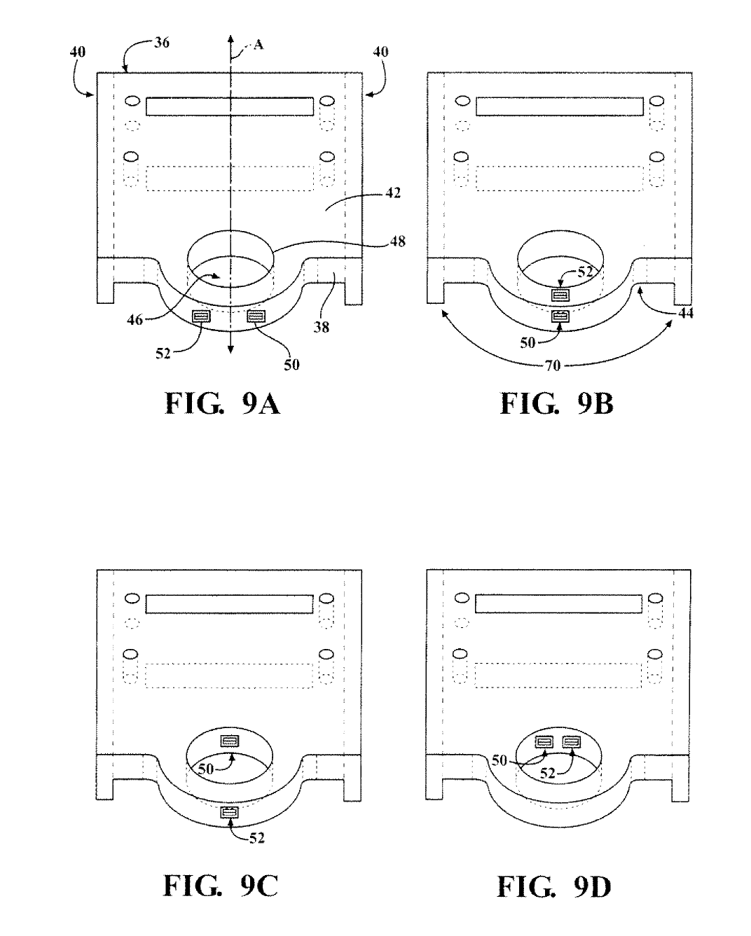

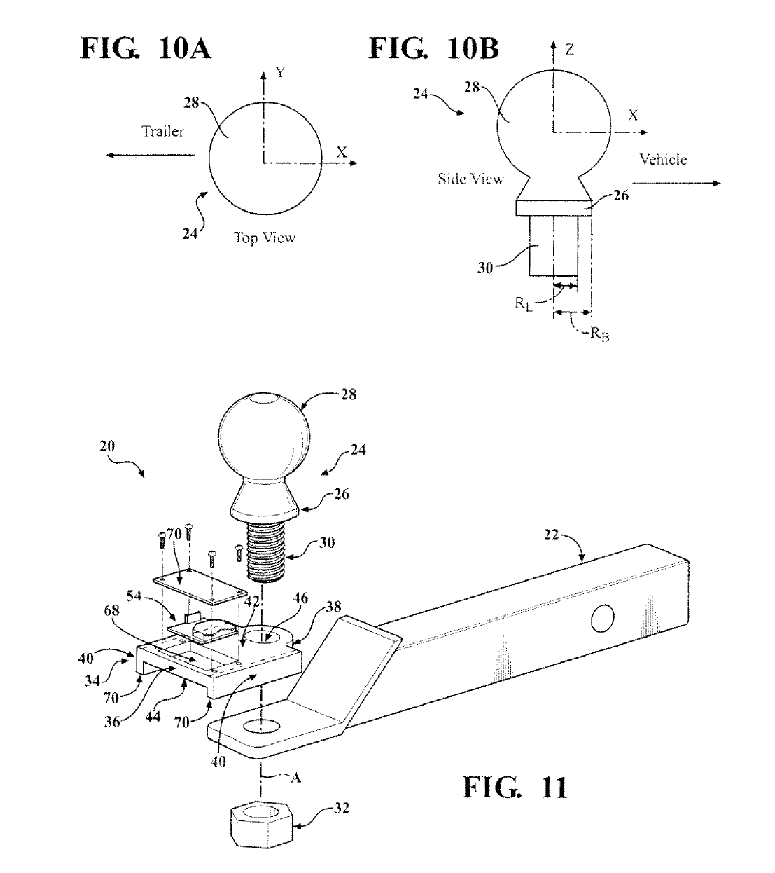

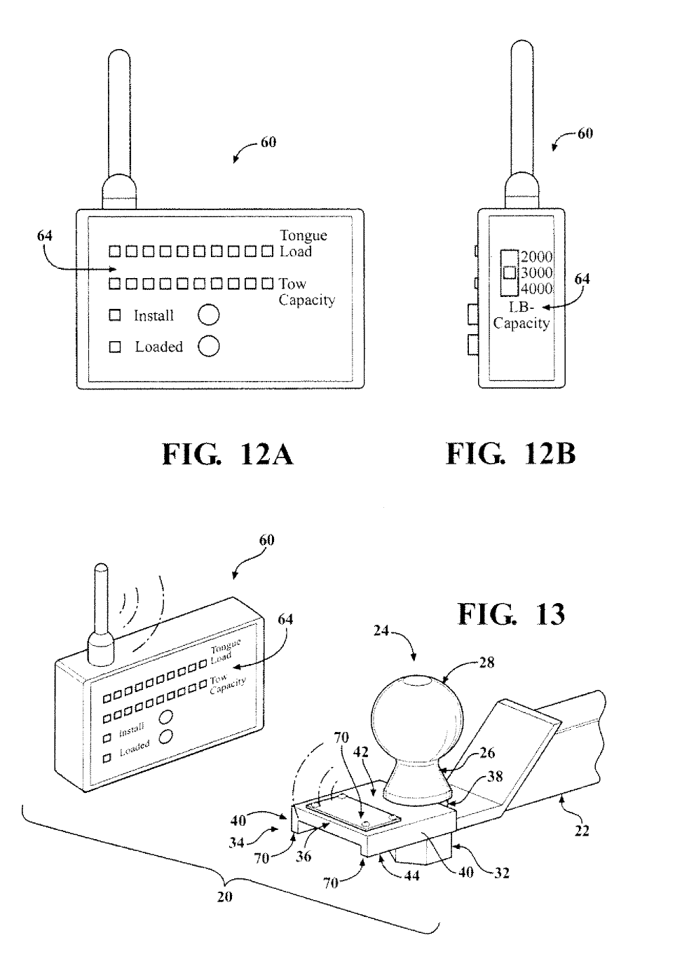

### DETAILED DESCRIPTION OF THE ENABLING EMBODIMENTS

Referring to the Figures, wherein like numerals indicate corresponding parts throughout the several views, an assembly 20 for monitoring the trailer hitch loads of a tow vehicle is provided.

The assembly 20 includes a hitch support 22 attached to the tow vehicle. The hitch support 22 may be integral with the vehicle or a receiver type trailer hitch which allows for the removal of the hitch support 22 from the tow vehicle. A hitch 24 coupled to the hitch support 22 is also provided. The hitch 24 includes a hitch base 26 and a hitch ball 28 disposed on and above the hitch base 26. The hitch base 26 has a hitch base radius R_{H}. A lug 30 having a cylindrical shape extends downwardly from the hitch base 26. The lug 30 has threads and a lug radius R_{L} that is less than the hitch base radius R_{H}. A nut 32 having threads threadedly engages the lug 30 of the hitch 24 to couple the hitch 20 and the hitch support 22. Various size hitch balls 28 may be employed to assure proper coupling with a trailer. Some common hitch ball sizes includes 1⅞ inches, 50 millimeters (1.97 inches) (ISO standard), 2 inches, and 2 5/16 inches.

An instrument spacer 34 is disposed between the hitch base 26 and the hitch support 22. The instrument spacer 34 includes a fore end 36 facing the tow vehicle and an aft end 38 opposite the fore end 36. The instrument spacer 34 further includes a pair of sides 40 spaced between the fore end 36 and the aft end 38. The instrument spacer 34 has a top surface 42 abutting the hitch base 26. The top surface 42 extends between the fore end 36, the aft end 38, and the sides 40. The instrument spacer 34 also has a bottom surface 44 abutting the hitch support 22. The bottom surface 44 extends between the fore end 36, the aft end 38, and the sides 40. The instrument spacer 34 defines a cylindrical bore 46 adjacent the aft end 38. The cylindrical bore 46 extends along a central bore axis A from the top surface 42 of the instrument spacer 34 to the bottom surface 44 of the instrument spacer 34. The cylindrical bore 46 has a bore face 48 of cylindrical shape and a bore radius R_{B} extending between the bore face 48 and the central bore axis A. The bore radius R_{B} is less than the hitch base 26 radius. The cylindrical bore 46 receives the lug 30 of the hitch 24.

The assembly 20 further includes at least one strain gauge 50 disposed on the instrument spacer 34. More specifically, the at least one strain gauge 50 is disposed on the instrument spacer 34 at a radial distance D from the central bore axis A that is less than or equal to the hitch base radius R_{H} and greater than or equal to the bore radius R_{B}. While the at least one strain gauge 50 may be placed anywhere where the radial distance D between it and the central bore axis A is less than or equal to the hitch base radius R_{H} and greater than or equal to the bore radius R_{B}, there are a number of preferred arrangements. According to one arrangement, the at least one strain gauge 50 may be disposed on the bore face 48. According to another arrangement, the at least one strain gauge 50 may be disposed on the aft end 38 of the instrument spacer 34.

The at least one strain gauge 50 may also be a plurality of strain gauges 50. Any number of strain gauges 50 is envisioned but the plurality of strain gauges may include a first strain gauge 50 and a second strain gauge 52. While any individual strain gauge 50 of the plurality of strain gauges may be placed anywhere where the radial distance D between it and the central bore axis A is less than or equal to the hitch base radius R_{H} and greater than or equal to the bore radius R_{B}, there are a number of preferred arrangements. According to one arrangement, the first strain gauge 50 may be disposed on the bore face 48 and the second strain gauge 52 may be disposed on the aft end 38 of the instrument spacer 34. Under this arrangement, the first strain gauge 50 may be disposed on the bore face 48 adjacent the aft end 38 of the instrument spacer 34. Alternatively, the first strain gauge 50 may be disposed on the bore face 48 nearest the aft end 38 of said instrument spacer 34. According to another arrangement, both the first strain gauge 50 and the second strain gauge 52 may be disposed on the bore face 48. Under this arrangement, both the first strain gauge 50 and the second strain gauge 52 may be disposed on the bore face 48 adjacent the aft end 38 of the instrument spacer 34. Alternatively, both the first strain gauge 50 and the second strain gauge 52 may be disposed on the bore face 48 nearest the fore end 36 of the instrument spacer 34. According to another arrangement, both the first strain gauge 50 and the second strain gauge 52 may be disposed on the aft end 38 of the instrument spacer 34.

The at least one strain gauge 50 is employed accordingly to these various arrangements to measure strain applied to the instrument spacer 34 by the hitch 24 as the hitch 24 is acted on by various forces. These forces can include a tongue load force F_{L}, a towing force F_{T}, a resultant force F_{R}, and a torque value T. The tongue load force F_{L} is the vertical force resulting from a moment imbalance due to the weight of the trailer as well as the weight of the load on the trailer relative to the position of the trailer axle(s). This is commonly referred to as tongue weight. The towing force F_{T} is the horizontal force resulting from movement of the trailer relative to the tow vehicle. Accordingly, the magnitude and direction of towing force F_{T} varies depending on whether the trailer is accelerating or decelerating (braking). The resultant force F_{R} is a sum of the tongue load force F_{L}, a towing force F_{T} and represents the total force acting on the hitch 24 at any given time. The torque value T is a measurement of the moment (twisting force about the central bore axis) applied to the hitch 24. It is useful in measuring whether the hitch 24 has been properly secured to the hitch support 22 (that the nut 32 has been properly tightened about the lug 30).

The at least one strain gauge 50 measures the strain applied to the instrument spacer 34 by generating a resistance change in response to the strain applied to the at least one strain gauge 50. More specifically, the resistance of the at least one strain gauge 50 increase when the at least one strain gauge 50 is placed under tension. Likewise, the resistance of the at least one strain gauge 50 decreases when the at least one strain gauge 50 is placed under compression. The at least one strain gauge 50 is electrically connected to a data acquisition system 54. The data acquisition system 54 may include one or more Wheatstone bridge circuits 56. The one or more Wheatstone bridge circuits 56 measure the resistance change of the at least one strain gauge 50 and generate a force measurement. The data acquisition system 54 may also include a transmitter 58 electrically connected to the one or more Wheatstone bridge circuits 56. The transmitter 58 then wirelessly transmits the force measurement received from the one or more Wheatstone bridge circuits 56.

A receiver base 60 includes a receiver 62 receiving the force measurement wirelessly transmitted by the transmitter 58. The receiver base 60 also may include a user information display 64 electrically connected to the receiver 62. The user information display 64 graphically presents the force measurement. The user information display 64 may or may not be attached to the tow vehicle. The user information display 64 may include light arrays indicating the magnitude of the tongue load and the tow capacity measured. The user information display 64 may also include a light array indicating whether the instrument spacer 34 and the hitch 24 is properly installed (that the nut 32 is properly tightened to the lug 30). The user information display 64 may also include a light array indicating whether the hitch 24 is loaded (non-zero tongue load force F_{L} indicating that the trailer is coupled to the hitch ball 28). Of course while the subject invention envisions wireless communication between the data acquisition system 54 and the user information display 64, the transmitter 58 and receiver 62 may be eliminating and replaced with wired electrical connections to facilitate communication between the data acquisition system 54 and the user information display 64.

The assembly 20 may include an accelerometer 66 electrically connected to the data acquisition system 54. The accelerometer 66 generates an acceleration measurement and relays the acceleration measurement to the data acquisition system 54 The towed mass value, the trailer sway value, and the suspension oscillation value can be used in the control of the braking system and suspension system of the tow vehicle and the trailer. The towed mass value, the trailer sway value, and the suspension oscillation value can also be used in the control of the transmission and throttle of the tow vehicle. The accelerometer 66 may take many forms but may be a three axis accelerometer 66 providing acceleration measurement along an x-axis X, a y-axis Y, and a z-axis Z. The acceleration measurement along the x-axis X can be used to determine the towed mass value which is equal to the mass of the trailer. The acceleration measurement along the y-axis Y can be used to determine the trailer sway value which quantizes tow vehicle and trailer sway. The acceleration measurement along the z-axis Z can be used to determine the suspension oscillation value which quantizes suspension oscillations of tow vehicle and trailer.

The top surface 42 of the instrument spacer 34 may also define a recess 68 receiving the data acquisition system 54 and the accelerometer 66. A recess cover 70 may be disposed over the recess 68 to cover the data acquisition system 54 and the accelerometer 66 and protect those electrical components from the environment. The recess cover 70 attaches to the top surface 42 of the instrument spacer 34. Attachment of the recess cover 70 to the top surface 42 of the instrument spacer 34 may be accomplished in many ways including but not limited to the use of screws, bolts, nails, rivets, clips, clamps, adhesives, welds, and sliding tracks.

The pair of sides 40 of the instrument spacer 34 may extend downwardly from the bottom surface 44 of the instrument spacer 34 to define a pair of ridges 72. The pair of ridges 70 project from the bottom surface 44 of the instrument spacer 34 and engage the hitch support 22. The pair of ridges 72 in conjunction with the hitch 24 and nut 32 secure the instrument spacer 34 to the hitch support 22. More specifically, the instrument spacer 34 is sandwiched between the hitch base 26 and the hitch support 22 as the nut 32 is tightened about the lug 30 of the hitch 24 to prevent axial movement along the central bore axis A. The pair of ridges 72 engage the hitch support 22 to prevent rotation of the instrument spacer 34 about the central bore axis A relative to the hitch support 22.

The subject invention also provides a method for monitoring a trailer hitch assembly 20. The trailer hitch assembly 20 includes a hitch support 22. The trailer hitch assembly 20 also has a hitch 24 including a hitch base 26 having a hitch base radius R_{H} and a lug 30 extending from the hitch base 26. The trailer hitch assembly 20 further includes an instrument spacer 34 disposed between the hitch base 26 and the hitch support 22. The instrument spacer 34 defines a cylindrical bore 46 receiving the lug 30 of the hitch 24. The cylindrical bore 46 extends along a central bore axis A. The cylindrical bore 46 has a bore face 48 and a bore radius R_{B} that is less than the hitch base radius R_{H}. The trailer hitch assembly 20 further includes at least one strain gauge 50 disposed on the instrument spacer 34 generating a resistance change and a user information display 64. The method comprises the steps of positioning the at least one strain gauge 50 on the instrument spacer 34 at a radial distance D from the central bore axis A that is less than or equal to the hitch base radius R_{H} and greater than or equal to the bore radius R_{B}. The method proceeds by measuring the resistance change of the at least one strain gauge 50 using a Wheatstone bridge circuit 56, calculating a resultant force value in response to measuring the resistance change of the least one strain gauge 50, calculating a torque value in response to measuring the resistance change of the least one strain gauge 50, and displaying at least one of the resultant force value and the torque value on the user information display 64. The method may also include the step of positioning the at least one strain gauge 50 on the bore face 48.

The method may also including monitoring a trailer hitch assembly 20 also including an accelerometer 66 providing acceleration measurement along an x-axis X, a y-axis Y, and a z-axis Z. The method may further comprise the steps of calculating a towed mass value in response to the acceleration measurement along the x-axis X, calculating a trailer sway value in response to the acceleration measurement along the y-axis Y, and calculating a suspension oscillation value in response to the acceleration measurement along the z-axis Z. The towed mass value is equal to the mass of the trailer. The trailer sway value quantizes tow vehicle and trailer sway. The suspension oscillation value quantizes suspension oscillations of tow vehicle and trailer.

Obviously, many modifications and variations of the present invention are possible in light of the above teachings and may be practiced otherwise than as specifically described while within the scope of the appended claims. These antecedent recitations should be interpreted to cover any combination in which the inventive novelty exercises its utility. The use of the word “said” in the apparatus claims refers to an antecedent that is a positive recitation meant to be included in the coverage of the claims whereas the word “the” precedes a word not meant to be included in the coverage of the claims.

What is claimed is:

1. An assembly for a monitoring the trailer hitch loads of a tow vehicle comprising;
a hitch support,
a hitch coupled to said hitch support including a hitch base having a hitch base radius and a hitch ball disposed on and above said hitch base and a lug extending downwardly from said hitch base,
an instrument spacer disposed between said hitch base and said hitch support defining a cylindrical bore receiving said lug and extending along a central bore axis and having a bore radius being less than said hitch base radius, and
at least one strain gauge disposed on said instrument spacer at a radial distance from said central bore axis being less than or equal to said hitch base radius and greater than or equal to said bore radius.

2. An assembly as set forth in claim 1 wherein said cylindrical bore has a bore face of cylindrical shape and said at least one strain gauge is disposed on said bore face.

3. An assembly as set forth in claim 2 wherein said at least one strain gauge includes a first strain gauge and a second strain gauge disposed on said bore face.

4. An assembly as set forth in claim 2 wherein said hitch support is attached to the tow vehicle and said instrument spacer includes a fore end facing the tow vehicle and an aft end opposite said fore end and a pair of sides and a top surface abutting said hitch base and extending between said fore end and said aft end and said sides and a bottom surface abutting said hitch support and extending between said fore end and said aft end and said sides.

5. An assembly as set forth in claim 4 wherein said at least one strain gauge includes a first strain gauge disposed on said bore face and a second strain gauge disposed on said aft end of said instrument spacer.

6. An assembly as set forth in claim 5 wherein said first strain gauge is disposed on said bore face adjacent said aft end of said instrument spacer.

7. An assembly as set forth in claim 5 wherein said first strain gauge is disposed on said bore face nearest said fore end of said instrument spacer.

8. An assembly as set forth in claim 4 wherein said at least one strain gauge includes a first strain gauge and a second strain gauge disposed on said bore face adjacent said aft end of said instrument spacer.

9. An assembly as set forth in claim 4 wherein said at least one strain gauge includes a first strain gauge and a second strain gauge disposed on said bore face nearest said fore end of said instrument spacer.

10. An assembly as set forth in claim 1 wherein said hitch support is attached to the tow vehicle and said instrument spacer includes a fore end facing the tow vehicle and an aft end opposite said fore end and a pair of sides and a top surface abutting said hitch base and extending between said fore end and said aft end and said sides and a bottom surface abutting said hitch support and extending between said fore end and said aft end and said sides and said at least one strain gauge is disposed on said aft end of said instrument spacer.

11. An assembly as set forth in claim 1 wherein said hitch support is attached to the tow vehicle and said instrument spacer includes a fore end facing the tow vehicle and an aft end opposite said fore end and a pair of sides and a top surface abutting said hitch base and extending between said fore end and said aft end and said sides and a bottom surface abutting said hitch support and extending between said fore end and said aft end and said sides.

12. An assembly as set forth in claim 11 wherein said pair of sides of said instrument spacer extend downwardly from said bottom surface of said instrument spacer to define a pair of ridges projecting from said bottom surface and engaging said hitch support.

13. An assembly as set forth in claim 12 wherein said top surface of said instrument spacer defines a recess receiving a data acquisition system electrically connected to said at least one strain gauge including a Wheatstone bridge circuit for generating a force measurement.

14. An assembly as set forth in claim 13 further comprising an accelerometer electrically connected to said data acquisition system generating an acceleration measurement and relaying said acceleration measurement to said data acquisition system for determining a towed mass value, a trailer sway value, and a suspension oscillation value.

15. An assembly as set forth in claim 13 further comprising a recess cover disposed over and covering said recess and attached to said top surface of said instrument spacer.

16. An assembly for monitoring the trailer hitch loads of a tow vehicle comprising;
a hitch support attached to the tow vehicle,
a hitch including a hitch base having a hitch base radius and a hitch ball disposed on and above said hitch base and a lug of cylindrical shape extending downwardly from said hitch base and having threads and a lug radius less than said hitch base radius,
a nut having threads threadedly engaging said lug of said hitch to couple said hitch and said hitch support,
an instrument spacer disposed between said hitch base and said hitch support including a fore end facing the tow vehicle and an aft end opposite said fore end and a pair of sides spaced between said fore end and said aft end and a top surface abutting said hitch base and extending between said fore end and said aft end and said sides and a bottom surface abutting said hitch support and extending between said fore end and said aft end and said sides and said instrument spacer defining a cylindrical bore adjacent said aft end receiving said lug of said hitch and extending along a central bore axis from said top surface to said bottom surface and said cylindrical bore having a bore face of cylindrical shape and a bore radius extending between said bore face and said central bore axis being less than said hitch base radius,
at least one strain gauge disposed on said instrument spacer generating a resistance change for measuring forces applied to said instrument spacer,
a data acquisition system electrically connected to said at least one strain gauge including a Wheatstone bridge circuit measuring said resistance change of said at least one strain gauge and generating a force measurement and a transmitter electrically connected to said Wheatstone bridge circuit and wirelessly transmitting said force measurement,
a receiver base including a receiver receiving said force measurement from said transmitter and a user information display electrically connected to said receiver and graphically presenting said force measurement,
said at least one strain gauge disposed on said instrument spacer at a radial distance from said central bore axis being less than or equal to said hitch base radius and greater than or equal to said bore radius,
said pair of sides of said instrument spacer extending downwardly from said bottom surface of said instrument spacer to define a pair of ridges projecting from said bottom surface and engaging said hitch support,
said top surface of said instrument spacer defining a recess receiving said data acquisition system,
an accelerometer disposed in said recess and electrically connected to said data acquisition system generating an acceleration measurement and relaying said acceleration measurement to said data acquisition system for determining a towed mass value, a trailer sway value, and a suspension oscillation value, and
a recess cover disposed over and covering said recess and attached to said top surface of said instrument spacer.

17. An assembly as set forth in claim 16 wherein said at least one strain gauge is disposed on said bore face.

18. An assembly as set forth in claim 17 wherein said at least one strain gauge includes a first strain gauge disposed on said bore face and a second strain gauge disposed on said aft end of said instrument spacer.

19. An assembly as set forth in claim 18 wherein said first strain gauge is disposed on said bore face adjacent said aft end of said instrument spacer.

20. An assembly as set forth in claim 18 wherein said first strain gauge is disposed on said bore face nearest said aft end of said instrument spacer.

21. An assembly as set forth in claim 17 wherein said at least one strain gauge includes a first strain gauge and a second strain gauge disposed on said bore face.

22. An assembly as set forth in claim 21 wherein said first strain gauge and said second strain gauge are disposed on said bore face adjacent said aft end of said instrument spacer.

23. An assembly as set forth in claim 21 wherein said first strain gauge and said second strain gauge are disposed on said bore face nearest said fore end of said instrument spacer.

24. An assembly as set forth in claim 16 wherein said at least one strain gauge is disposed on said aft end of said instrument spacer.

25. A trailer hitch monitoring apparatus for attachment between a hitch support coupled to a tow vehicle and a hitch including a hitch base having a hitch base radius and a hitch ball disposed on and above the hitch base and a lug extending downwardly from the hitch base, said trailer hitch monitoring apparatus comprising;
an instrument spacer disposed between the hitch base and the hitch support defining a cylindrical bore extending along a central bore axis and receiving the lug of the hitch and having a bore radius being less than the hitch base radius, and
at least one strain gauge disposed on said instrument spacer at a radial distance from said central bore axis being less than or equal to the hitch base radius and greater than or equal to said bore radius.

26. An assembly as set forth in claim 25 wherein said cylindrical bore has a bore face of cylindrical shape and said at least one strain gauge is disposed on said bore face.

27. An assembly as set forth in claim 26 wherein said at least one strain gauge includes a first strain gauge and a second strain gauge disposed on said bore face.

28. An assembly as set forth in claim 26 wherein said instrument spacer includes a fore end facing the tow vehicle and an aft end opposite said fore end and a pair of sides and a top surface abutting said hitch base and extending between said fore end and said aft end and said sides and a bottom surface abutting said hitch support and extending between said fore end and said aft end and said sides.

29. An assembly as set forth in claim 28 wherein said at least one strain gauge includes a first strain gauge disposed on said bore face and a second strain gauge disposed on said aft end of said instrument spacer.

30. An assembly as set forth in claim 29 wherein said first strain gauge is disposed on said bore face adjacent said aft end of said instrument spacer.

31. An assembly as set forth in claim 29 wherein said first strain gauge is disposed on said bore face nearest said fore end of said instrument spacer.

32. An assembly as set forth in claim 28 wherein said at least one strain gauge includes a first strain gauge and a second strain gauge disposed on said bore face adjacent said aft end of said instrument spacer.

33. An assembly as set forth in claim 28 wherein said at least one strain gauge includes a first strain gauge and a second strain gauge disposed on said bore face nearest said fore end of said instrument spacer.

34. An assembly as set forth in claim 25 wherein said hitch support is attached to the tow vehicle and said instrument spacer includes a fore end facing the tow vehicle and an aft end opposite said fore end and a pair of sides and a top surface abutting said hitch base and extending between said fore end and said aft end and said sides and a bottom surface abutting said hitch support and extending between said fore end and said aft end and said sides and said at least one strain gauge is disposed on said aft end of said instrument spacer.

35. An assembly as set forth in claim 25 wherein said hitch support is attached to the tow vehicle and said instrument spacer includes an a fore end facing the tow vehicle and an aft end opposite said fore end and a pair of sides and a top surface abutting said hitch base and extending between said fore end and said aft end and said sides and a bottom surface abutting said hitch support and extending between said fore end and said aft end and said sides.

36. An assembly as set forth in claim 35 wherein said pair of sides of said instrument spacer extend downwardly from said bottom surface of said instrument spacer to define a pair of ridges projecting from said bottom surface and engaging said hitch support.

37. An assembly as set forth in claim 36 wherein said top surface of said instrument spacer defines a recess receiving a data acquisition system electrically connected to said at least one strain gauge including a Wheatstone bridge circuit for generating a force measurement.

38. An assembly as set forth in claim 37 further comprising an accelerometer electrically connected to said data acquisition system generating an acceleration measurement and relaying said acceleration measurement to said data acquisition system for determining a towed mass value, a trailer sway value, and a suspension oscillation value.

39. An assembly as set forth in claim 37 further comprising a recess cover disposed over and covering said recess and attached to said top surface of said instrument spacer.

40. A method for monitoring a trailer hitch assembly including a hitch support and a hitch including a hitch base having a hitch base radius and a lug extending from the hitch base and an instrument spacer disposed between the hitch base and the hitch support defining a cylindrical bore receiving the lug of the hitch and extending along a central bore axis and the cylindrical bore having a bore face and a bore radius being less than the hitch base radius and at least one strain gauge disposed on the instrument spacer generating a resistance change and a user information display, comprising the steps of;
positioning the at least one strain gauge on the instrument spacer at a radial distance from the central bore axis being less than or equal to the hitch base radius and greater than or equal to the bore radius,
measuring the resistance change of the at least one strain gauge using a Wheatstone bridge circuit,
calculating a resultant force value in response to measuring the resistance change of the least one strain gauge,
calculating a torque value in response to measuring the resistance change of the least one strain gauge, and
displaying at least one of the resultant force value and the torque value on the user information display.

41. A method as set forth in claim 40 further comprising the step of positioning the at least one strain gauge on the bore face.

42. A method as set forth in claim 40 wherein the trailer hitch assembly also includes an accelerometer providing acceleration measurement along an x-axis, a y-axis, and a z-axis, further comprising the steps of;
calculating a towed mass value in response to the acceleration measurement along the x-axis,
calculating a trailer sway value in response to the acceleration measurement along the y-axis, and
calculating a suspension oscillation value in response to the acceleration measurement along the z-axis.
